(19) United States
(12) Patent Application Publication
(10) Pub. No.: US 2021/0192574 A1
(43) Pub. Date: Jun. 24, 2021

(54) TECHNIQUES TO INCENTIVIZE SHARING ELECTRONIC ADVERTISEMENT INFORMATION IN A COMPUTE ENVIRONMENT

(71) Applicant: Capital One Services, LLC, McLean, VA (US)

(72) Inventors: Austin Grant WALTERS, Savoy, IL (US); Jeremy Edward GOODSITT, Champaign, IL (US); Fardin ABDI TAGHI ABAD, Champaign, IL (US)

(73) Assignee: Capital One Services, LLC, McLean, VA (US)

(21) Appl. No.: 16/726,804

(22) Filed: Dec. 24, 2019

(51) Int. Cl. G06Q 30/02; G06Q 20/38; G06Q 20/06; H04W 4/23

(52) U.S. Cl. CPC G06Q 30/0267; G06Q 30/0255; G06Q 20/389; H04W 84/18; G06Q 30/0215; H04W 4/23; G06Q 2220/00; G06Q 20/0658

(57) ABSTRACT

Various embodiments are generally directed to systems and techniques to process information in a mesh network environment. Further, embodiments include communicating and processing a targeted advertisement payload on a closed mesh network. The target ad payload can include information such as targeted ad content, a unique hash value, and an incentive offer. The target ad content includes ad content that is presentable on the mesh network. Further, the unique hash value and incentive offer is utilized by one or more nodes to cause the ad content to be presented on nodes outside of the mesh network.

### BACKGROUND

Many venues now offer local networking services in a mesh or localized network type architecture. In providing these services, a venue may also distribute advertisements with respect to goods and/or services that they may provide. The advertisements may be provided as graphical ads or banners on a display of a user device, for example. Providing advertisements in this manner is an inexpensive way to advertise to customers located within the venue itself. However, current solutions typically do not enable the venue operators to advertise to potential customers that are not located inside of venue and/or connected to the local network unless they utilize broader, more costly strategy.

### SUMMARY

This disclosure presents various systems, components, and methods related to using a blockchain within a mesh network. Each of the systems, components, and methods disclosed herein provides one or more advantages over conventional systems, components, and methods. Various embodiments include techniques for communicating a targeted advertisement payload onto the closed mesh network, the targeted ad payload includes a targeted ad content for presentation of an advertisement on a first subset of nodes of the plurality of nodes, the first subset of nodes are intended targets of the target ad content, a unique hash value, and an incentive offer for a second subset of nodes of the plurality of nodes, the second subset of nodes not intended targets of the target ad content. Embodiments further include determining that a second node, of the second subset of nodes, communicated the target ad content to at least one node not of the closed mesh network, determining, by the node, that a third node of the at least one node not of the closed mesh network accessed the target ad content based on the unique hash value, and awarding, by the node, the incentive offer to the second node based on the determination the third node accessed the targeted ad content.

### BRIEF DESCRIPTION OF THE DRAWINGS

FIGS. 1A/1B/1C illustrate example configurations of a system and operating environment.

FIGS. 2A/2B illustrate example logic flows to provide advertisement content.

FIG. 3 illustrates an example logic flow to share an advertisement.

FIG. 4 illustrates an example logic flow to process an engagement of an advertisement.

FIG. 5 illustrates an example of a storage medium.

FIG. 6 illustrates an example of a system architecture.

FIG. 7 illustrates an example of a communication architecture.

FIG. 8 illustrates an example of a blockchain.

### DETAILED DESCRIPTION

Various embodiments are generally directed to techniques to provide targeted advertisements in a closed mesh network. Embodiments may further include providing an electronic incentive offer to incentivize nodes within the mesh network to send the advertisement to devices outside of the mesh network. Thus, embodiments discussed herein are advantageous over existing solutions because they enable merchant systems on a closed mesh network to reach potential customer systems that are outside of the closed mesh network.

Further, embodiments may include a system or node that may communicate a targeted advertisement payload onto a mesh network, the targeted ad payload may include an advertisement that is targeted to specific customers based on prior transactional history associated with those customers. In embodiments, the target ad payload may include targeted ad content for presentation of an advertisement on the targeted nodes. Target ad payload may also include an incentive offer for the nodes of the system including targeted and untargeted nodes. The incentive offer may be an offer to pay customers to share the advertisement with devices that are outside of the mesh network.

In embodiments, a node, targeted or untargeted, may share the advertisement with a device outside of the mesh network, and customer of the device may engage the advertisement. For example, a customer may click or invoke the advertisement and go to a website associated with the advertisement. In some instances, the customer may make purchase for a good or service associated with the advertisement.

Embodiments further include the system determining that a customer, outside of the mesh network, engaged the advertisement through a node of the mesh networking sharing it. The system may determine to send a payment to the node that shared the advertisement outside of the mesh network. These and other details will in more detail in the following description.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well-known structures and devices are shown in block diagram form to facilitate a description thereof. The intention is to cover all modifications, equivalents, and alternatives within the scope of the claims.

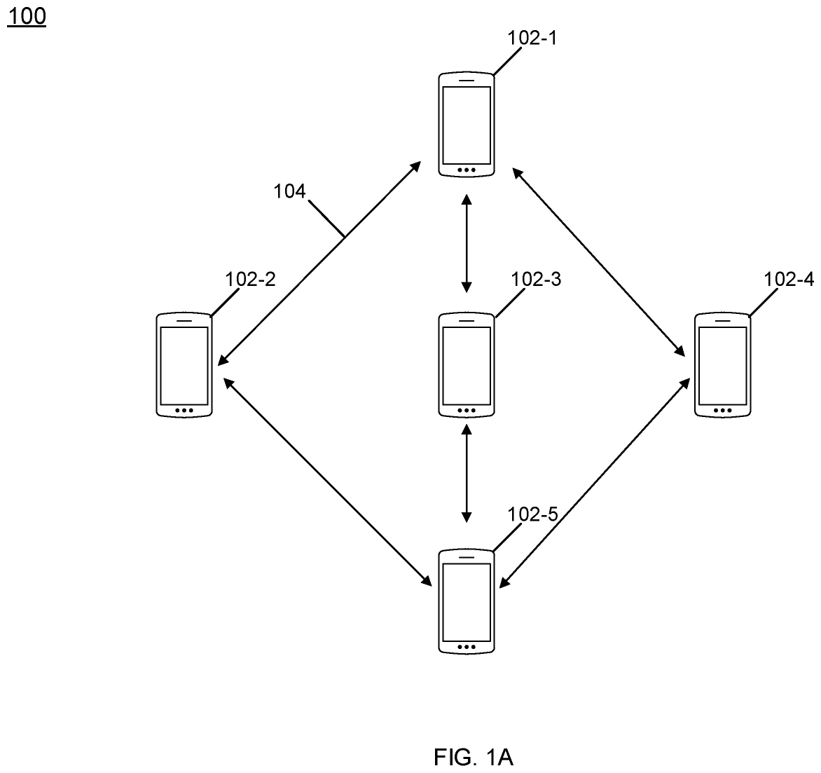

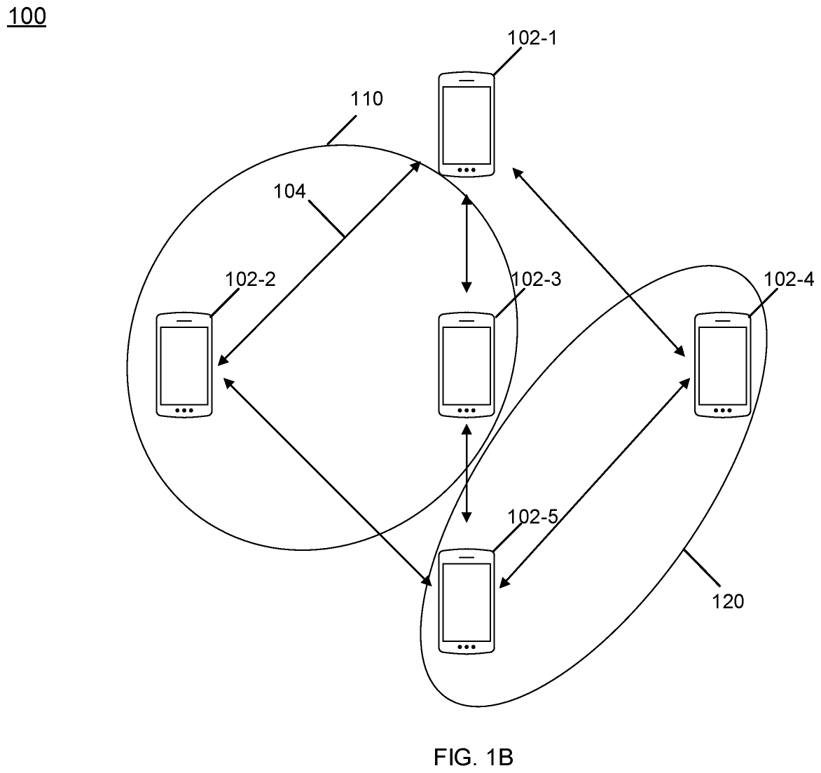

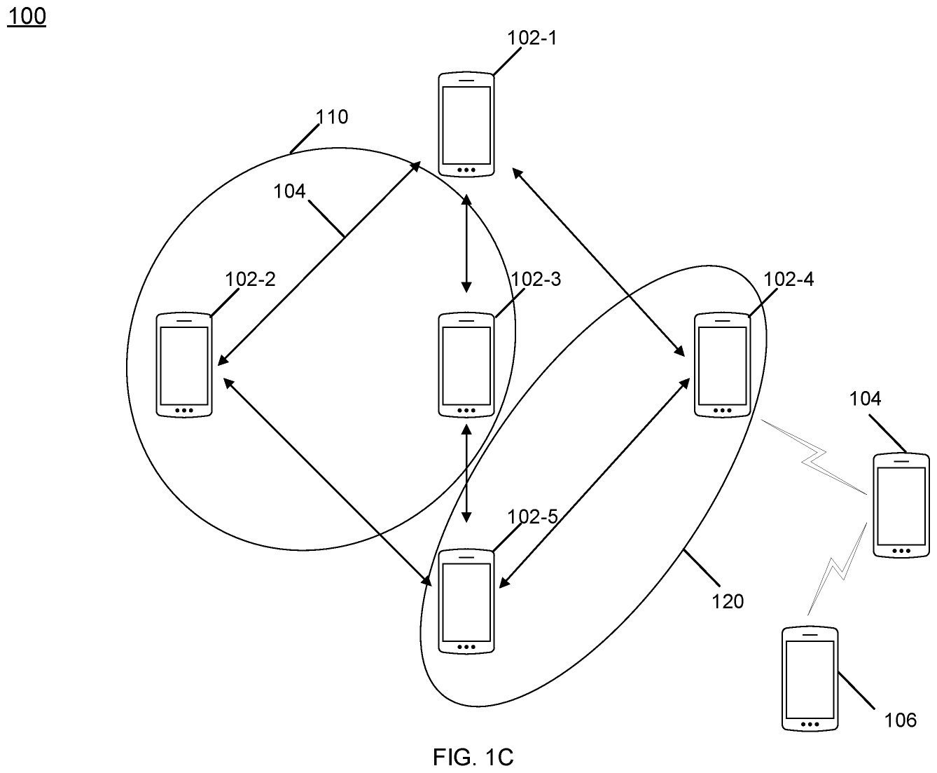

FIG. 1 illustrates an operating environment 100 such as may be representative of various embodiments in which techniques for providing a secure network may be implemented. The operating environment 100 can be a mesh network and can include a first node 102-1, a second node 102-2, a third node 102-3, a fourth node 102-4, and a fifth node 104-5 node. The mesh network 100 is not limited to the number of nodes depicted in FIG. 1.

In various embodiments, the mesh network 100 can be any type of mesh network and can operate according to any known mesh networking protocol or standard. In various embodiments, data, traffic, messages, or other communications within the mesh network 100 can be transmitted between the nodes 102, as described herein. In various embodiments, data, traffic, messages, or other communications within the mesh network 100 can be transmitted from an initial node to a desired recipient node through one or more intermediate nodes, with intermediate nodes passing communications intended for the desired recipient node to a next nearest neighbor or other node as described herein.

The mesh network 100 can be provided in an area without Internet access or with limited Internet access such as, for example, a farmer's market, a festival, or an office space. The mesh network 100 can provide a payment system within the mesh network 100 that does not require each node 102 to be connected directly to the Internet. In various embodiments, one or more nodes 102 can maintain a blockchain for a cryptocurrency that can support a payment system useable within the mesh network 100 and that can support secure communications within the mesh network 100.

In some instances, every node 102 of the mesh network 100 may support and maintain the cryptocurrency blockchain. Thus, each of the nodes 102 can process transactions related to the blockchain including, for example, updating the blockchain based on a transaction and distribute the updated blockchain. Transactions can be conducted within the mesh network 100 and can utilize the cryptocurrency blockchain maintained by the nodes 102. Communications or other messages can be transmitted within the mesh network 100 using encryption features provided by the cryptocurrency and/or blockchain such that the communications or other messages can be provided in a secure manner.

In some instances, some nodes 102 may be authorized to maintain the blockchain while others may not. As an example, the node 102-1 and the node 102-5 can each be considered to be an authorized node on the mesh network 100. In this example, the one or more of the authorized nodes 102-1 and 102-5 can maintain the blockchain for the cryptocurrency and can process transactions related to the blockchain. Transactions can be conducted within the mesh network 100 and can utilize the cryptocurrency blockchain maintained by one or more of the nodes 102-1 and 102-5.

The nodes 102-2, 102-3, and 102-4 can each be considered to be an unauthorized node. In various embodiments, as unauthorized nodes, the nodes 102-2, 102-3, and 102-4 can each route communications or other messages to an authorized node (e.g., the nodes 102-1 and 102-5) but cannot directly send messages to one another (e.g., the node 102-2 cannot directly send a message to the node 102-3). In various embodiments, as unauthorized nodes, the nodes 102-2, 102-3, and 102-4 may be allowed to receive and transmit communications, messages, or other traffic on a limited basis. In various embodiments, one or more of the authorized nodes 102-1 and 102-5 can determine the allowed level of participation on the mesh network 100 by the nodes 102-2, 102-3, and 102-4.

In embodiments, each of the nodes 102 within the mesh network 100 may communicate via connections or paths. For example, path 104 can represent a communication path between certain nodes on the mesh network 100 (e.g., between the node 102-1 and the node 102-2). Other paths 104 between certain nodes are shown in FIG. 1 but are not labeled for simplicity. The path 104 can indicate that communication between certain nodes is allowed or possible within the mesh network 100. In various embodiments, communications between the authorized node 102-1 and the authorized node 102-5 can be provided through the node 102-3—for example, the node 102-3 can relay messages between the authorized nodes 102-1 and 102-5. In various embodiments, a communication path is not shown between the node 102-3 and the node 102-4 since each node is unauthorized and cannot directly send messages to one another. Instead, the nodes 102-3 and 102-4 may be allowed to perform only limited functions with respect to the mesh network 100 as described herein. In other instances, paths may exist between each of the nodes 102. For example, although not shown, a path may exist between nodes 102-2 and 102-4. The paths may be based on the configuration of the mesh network 100.

In various embodiments, each of the nodes 102 can be associated with a cryptocurrency wallet that can be loaded with an amount of cryptocurrency (e.g., cryptocurrency tokens). In some instances, a central authority, e.g., a server, may issue the cryptocurrency wallets. In other instances, the authorized nodes 102-1 and 102-5 can issue the cryptocurrency wallets for the other nodes 102-2, 102-3, and 102-4, and themselves. The authorized nodes 102-1 and 102-5 can also control access to the mesh network 100. As an example, the authorized nodes 102-1 and 102-5 can grant or deny a request by another node 102 (e.g., the node 102-2) to join and participate on the mesh network 100. In various embodiments, only authorized nodes can be associated with a cryptocurrency wallet.

The authorized nodes 102-1 and 102-5 can be designated as such in a number of manners. In various embodiments, a node 102 can be considered an authorized node 102 once it holds or stores a certain amount or value of cryptocurrency. In various embodiment, a node 102 can be considered an authorized node 102 once a certain number of other nodes 102 (e.g., authorized nodes) determine the node 102 should be an authorized node. In various embodiments, a node 102 can be considered an authorized node 102 once it helps facilitate a certain number of transactions using the blockchain (e.g., helps authorize transactions based on the blockchain).

In general, to become an authorized node, one or more criteria must be met as described herein. Once a node becomes an authorized node, the node can communicate in any manner with any other node of the mesh network 100, can manage participation of other nodes on the mesh network including, for example, issuing cryptocurrency wallets, and can manage a blockchain of the cryptocurrency. An authorized node can receive payments (e.g., based on the cryptocurrency) for processing transactions and maintaining the blockchain and can receive payments for routing communications and other messages through the mesh network 100.

In contrast, unauthorized nodes are generally limited to routing communications and other messages to authorized nodes. In various embodiments, unauthorized nodes can receive payments (e.g., based on the cryptocurrency) for helping to facilitate transactions within the mesh network 100—for example, by routing traffic carrying data related to a transaction toward an authorized node and by helping to authorize a transaction (e.g., when a desired cryptocurrency transaction requires authorization from multiple nodes for verification). In various embodiments, unauthorized nodes can also receive payments for routing communications and other messages through the mesh network 100 (e.g., subject to any routing limitations related to operating as an authorized node). In various embodiments, one or more of the authorized nodes 102-1 and 102-5 can be connected to the Internet and/or a remote network. In various embodiments, the one or more of the authorized nodes 102-1 and 102-5 can ensure that a maintained blockchain is up to date and accurate with versions of the blockchain maintained outside of the mesh network 100.

For purposes of illustration and explanation only, five nodes 102 are shown in FIG. 1, but the number of nodes 102 capable of operating on the mesh network 100 is not so limited as any number of nodes 102 can be included within the mesh network 100. The nodes 102 can represent any type of electronic and/or computing device maintained by an operator or user including, for example, a smartphone, a tablet, a laptop, or any other consumer electronic device capable of operating as a node 102 on the mesh network 100. The operator or user of any of the nodes 102 can be a private individual or can be a business owner or merchant such that certain nodes 102 can represent merchant node (e.g., a node associated with the sale of a goods or services). Accordingly, transactions can be conducted entirely within the mesh network 100 using the blockchain between a POS node and an individual node and/or between two individual nodes.

In embodiments, nodes 102 may join and/or leave the mesh network from time-to-time. For example, to join the mesh network 102 a node 102 various can receive data or other information relating to the mesh network 100. In various embodiments, an application (app) or other program can be downloaded onto the node 102. The data or other information relating to the mesh network 100 and/or the downloaded app can be used to establish the electronic device and/or computing device as a node 102 on the mesh network 100.

After the computing device is established as the node 102 that is capable of operating on the mesh network 100, the node 102 can generate a cryptocurrency wallet, for example. The generated cryptocurrency wallet can be stored on the node 102—for example, within a storage device and/or memory unit of the computing device established as the node 102. The cryptocurrency wallet for the node 102 can be issued by an authorized node or central authority of the mesh network.

After generating a cryptocurrency wallet, the user of the computing device operating as the node 102 can load the generated cryptocurrency wallet with an amount of cryptocurrency tokens. The amount of cryptocurrency tokens can be issued by an authorized node of the mesh network or a central authority. As an example, the node 102 can provide a payment to an authorized node 102 in exchange for a corresponding amount of a cryptocurrency (e.g., cryptocurrency tokens).

In embodiments, a node 102 can conduct transactions within the mesh network 100 using cryptocurrency stored in a generated wallet. As an example, the node 102-1 can initiate and conduct a transaction with the node 102-5 (e.g., for a good or service offered by the node 102-5). Payment can be provided by the node 102-1 to the node 102-5 based on cryptocurrency stored in the generated wallet of the node 102-1. One or more nodes—such as the authorized node 102-1—can update and manage the blockchain to reflect the transaction between the node 102-1 and the node 102-5. Thus, the blockchain may store an indication of each transaction and details of the transaction, e.g., between which parties, good or service of the transaction, cost of the transaction, and so forth. To complete the transaction, transactional data or information can be transferred between the nodes 102-1 and 102-5 to facilitate the transaction. One or more other nodes, such as unauthorized nodes can transfer messages related to the transaction between the nodes 102-1 and 102-5. In doing so, the intermediate node(s) can receive a payment (e.g., from the node 102-1 and/or the node 102-5 or a central authority) for facilitating the transaction.

In various embodiments, the unauthorized nodes 102 can transmit and receive communications and/or other messages within the mesh network 100. As an example, the node 102-2 can generate and transmit communication messages within the mesh network 100. To do so, the node 102-2 can be required to issue a payment to each node 102 that helps facilitate transmission of the generated message from the node 102-2 as it is relayed through one or more intermediate nodes before reaching a desired destination node.

Further, the node 102-2 can be required to issue a payment to each node that helps facilitate a transaction initiated by the node 102-2. For example, the node 102-2 can be required to issue a payment to a node 102, such as an authorized node, that manages the cryptocurrency blockchain and to issue a payment to any node 102 that helps transmit any messages between nodes 102 that conduct a transaction. For example, the node 102-3 may receive payment from the node 102-2 for transferring messages—for example, messages related to a communication or messages related to a transaction—between the nodes 102-2 and the node 102-4. In this way, each node 102 on the mesh network 100 can receive payments for facilitating transactions and/or communications between other nodes 102 on the mesh network 100.

In various embodiments, messages relating to transactions can be routed to the authorized nodes 102-1 and the node 102-5 to facilitate management of the blockchain. The nodes 102-1 and 102-5 can manage the cryptocurrency blockchain and can therefore know the current state of the blockchain. The blockchain managed by the nodes 102-1 and 102-5 can be distributed within the mesh network 100 including, for example, a state of the blockchain.

In various embodiments, the mesh network 100 can operate without being under the control of a central authority. Instead, the mesh network 100 can be facilitated by several distributed authorized nodes that manage a payment system (e.g., cryptocurrency blockchain) that can be used to conduct transactions on the mesh network 100, with other nodes on the mesh network 100 routing transactional related traffic to the authorized nodes to earn payments, and routing secure communications between nodes to also earn payment. Communications can be made secure using private and/or public keys associated with generated cryptocurrency wallets as issued by the authorized nodes as described herein. For example, the public and/or private keys associated with the cryptocurrency wallets can be used to encrypt and decrypt messages sent within the mesh network to maintain the messages in a secure manner as described herein.

In various embodiments, a node 102 may join the mesh network 100 but may have limited capabilities within the mesh network 100 as regulated and controlled by the authorized nodes. In various embodiments, a node may only be allowed to participate on the mesh network 100 after having a certain amount of cryptocurrency stored in an associated wallet, by receiving authorization to participate from one of the authorized nodes, or by helping to facilitate a certain number of transactions (e.g., passing messages relating to financial transactions or verifying a requested transaction) or helping to facilitate transfer of data communications (e.g., by transferring or routing communications unrelated to a financial transaction to an authorized node).

In various embodiments, an unauthorized node can be elevated to an authorized node in a similar manner—i.e., by meeting certain criteria such as, for example, by having a certain amount of cryptocurrency stored in an associated wallet, by receiving full authorization from one of the existing authorized nodes, or by helping to facilitate a certain number of transactions (e.g., passing messages relating to financial transactions or verifying a requested transaction) or helping to facilitate transfer of data communications (e.g., by transferring or routing communications unrelated to a financial transaction to an authorized node).

In embodiments, a node 102 may be operated by a merchant system, e.g., a merchant node, and may communicate advertisements for goods and/or services to other nodes 102 of the mesh network 100. The advertisements may include targeted ad content (digital visual and/or audio content) capable of being displayed and played on one or more other nodes 102. For example, an advertisement may be presented within a webpage of a web browser application or within another application of a node 102.

In some embodiments, a merchant node may send an advertisement to every node 102 on the mesh network 100 or may target an advertisement to one or more specific nodes 102. The targeted nodes 102 may be picked based on prior transactional information stored in the blockchain. For example, the merchant node may determine, from transaction information on the blockchain, nodes 102 associated with transactions having similar products to the products offered by the merchant of the merchant node. The merchant may determine that users of these nodes 102 purchasing similar products to their own, may be more likely to purchase their product or the user of a targeted node 102 may notice or pay more attention to the advertisement. Embodiments are not limited to this example, as will be discussed in more detail below, machine-learning techniques may be applied to determine which nodes to send the targeted advertisements.

In embodiments, a merchant node may determine a set of nodes as targeted nodes to receive the advertisement, and determine a set of nodes as untargeted nodes that will not present the advertisement on the node. FIG. 1B illustrates an operating environment of the mesh network 100 including node 102-1 operating as a merchant node and the other nodes broken into two groups. The two groups may include targeted nodes 110 (nodes 102-2, and 102-3) and untargeted nodes 120 (nodes 102-4 and 102-5). The merchant node 102-1 may communicate a targeted advertisement payload onto the mesh network 100, which may be received and presented on the targeted nodes 102-2 and 102-3 and may not presented on the untargeted nodes 102-4 and 102-5. In some instances, untargeted nodes 102-4 and 102-5 may receive the advertisement and communicate the targeted advertisement payload to one or more other nodes 102, e.g., the targeted nodes 102-2 and 102-3, but may not present the advertisement on their own nodes. For example, node 102-3 may be an untargeted node and node 102-5 may be a targeted node. In this example, merchant node 102-1 may present the targeted advertisement payload on the mesh network 100, and untargeted node 102-3 may receive and forward the payload to the targeted node 102-5. Embodiments are not limited to this example. As will discussed in more detail below, nodes 102 may also send the targeted advertisement to nodes or devices that are not directly a member of the mesh network.

In embodiments, a targeted ad payload, presented on the mesh network 100 may include targeted ad content for presentation of an advertisement on the targeted nodes, e.g., nodes 102-2 and 102-3. The targeted ad payload may also include a unique hash value to identify the advertisement. For example, if an advertisement is engaged or invoked, e.g., a user clicks on the advertisement on a node 102, the unique hash value may be used to initiate a transaction through the mesh network 100 and used to identify the advertisement for presentation on the node 102 associated with the user. The transaction may be processed through the mesh network 100, e.g., communicated to the merchant node 102-1 directly or via one or more intermediary nodes 102.

In embodiments, the targeted ad payload may also include an incentive offer to pay another node 102, e.g., a non-merchant node or intermediary node, to communicate and send the targeted ad payload to one or more other nodes or devices that may or may not be part of the mesh network 100. If the targeted ad content provided by the other node 102 is invoked, the node 102 may receive payment from the merchant node 102-1. For example, the merchant node 102-1 may issue payment as a cryptocurrency token deposited into the cryptocurrency wallet of the node 102. In some instances, a number of nodes 102 may be in the chain of nodes providing the targeted ad content. In these instances, when the targeted ad content is invoked, the merchant node 102-1 may issue a portion of the payment to each of the nodes 102 in the chain of nodes. The chain nodes may include other nodes 102 of the mesh network 100, and/or nodes that are not part of the mesh network 100. Embodiments are not limited in this manner.

In some embodiments, the incentive offer may be offered to the untargeted nodes to incentivize them to share the targeted ad content with other nodes 102 in the mesh network 100 and/or devices or nodes outside of the mesh network 100. For example, FIG. 1C illustrates an example of the operating environment of the mesh network 100 including two nodes 104 and 106 that are not part of the mesh network 100. These nodes 104 and 106 may be any type of device or compute system and may be directly communicatively coupled with node 102-4 of the mesh network, but not with the other nodes 102-1, 102-2, 102-3, and 102-5 of the mesh network 100.

In this example, node 102-4 may be an untargeted node of a targeted ad payload and content. The node 102-4 itself may not present the targeted ad content but may host and/or communicate the targeted ad payload to one or more other nodes, such as nodes 104 and 106, that are not part of the mesh network 100. For example, the untargeted node 102-4 may receive the targeted ad payload from the merchant node 102-1 and communicate the targeted payload to node 104. In some instances, the node 102-4 may communicate the targeted ad payload to every other connected node or device. In other instances, the node 102-4 may target other nodes or devices based on transactional history associated with those nodes or devices.

In embodiments, the untargeted node-102-4 may receive the incentive offer associated with an advertisement if the advertisement is invoked on a node not part of the mesh network 100, e.g., node 104. A node that is not part of the mesh network 100 may itself communicate the targeted ad payload to other nodes. For example, node 104 may receive the targeted ad payload from node 102-4 and communicate the targeted ad payload to node 106. Note that node 106 may not be directly communicatively coupled with node 102-4 (or any other node 102 of the mesh network 100) but may receive the targeted ad payload from node 104. In this example, if the targeted ad content is invoked or engaged on node 106, both node 102-4 and node 104 may receive a portion of the incentive offer, which may be equal and/or divided between the nodes based on a sharing scheme. The merchant node 102-1 may issue a portion of the incentive offer to a cryptocurrency wallet of node 102-4 and a portion of the incentive offer to a cryptocurrency wallet associated with node 104. In some instances, the node 104 may not have a cryptocurrency wallet. The merchant node 102-1 may communicate the incentive offer to node 104 using a different means, e.g., depositing the portion in a bank account, communicating it directly, etc. In some instances, the incentive offer may be a standard fixed value incentive amount, e.g., one cryptocurrency token. Moreover, the incentive offer is not limited to cryptocurrency and may be paid via other methods; government issued currency, credit with the merchant, discount offers, reward points, and so forth.

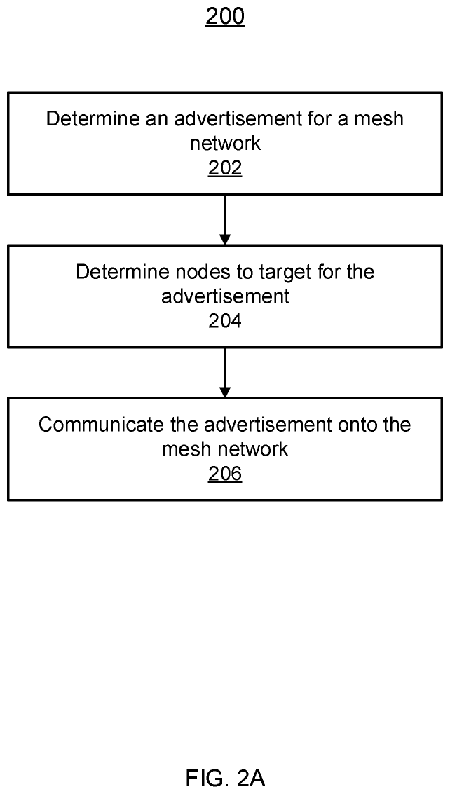

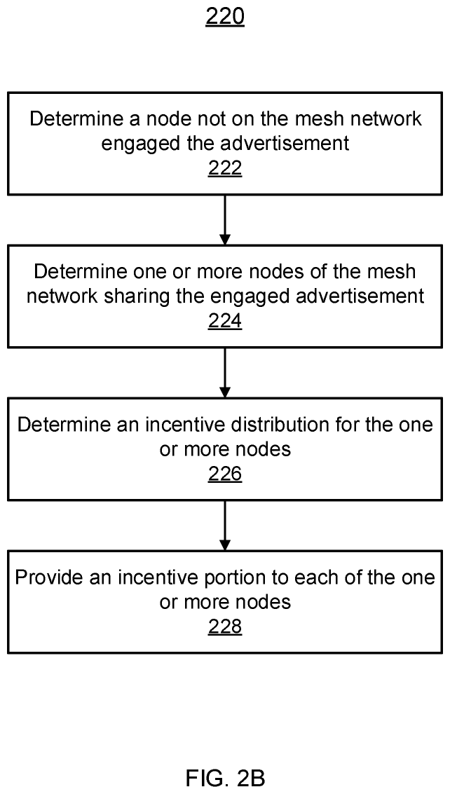

FIG. 2A illustrates an example of a logic flow 200 that may be representative of techniques for enabling a node in a mesh network to provide an advertisement. For example, the logic flow 200 may be representative of operations that may be performed in various embodiments by any constituent component of the mesh network 100 (e.g., any of the nodes 102 operating as a merchant node) depicted in FIG. 1.

For example, the logic flow 200 may include a node determining an advertisement for the mesh network at block 202. The advertisement may include visual and/or audio content that may be presented on one or more other nodes of the mesh network. For example, the advertisement may include content in a HyperText Markup Language (HTML) format and presented on a webpage of a web browser of a node. The advertisement may be written in any code or format and may be configured for a particular platform. For example, the advertisement may be in a query language format, such as Google's® Ads Query Language, to be presented in applications for a mobile device platform, such as Android®. In embodiments, the advertisement may be programmed to communicate with an application programming interface (API) associated with the app hosting platform. Embodiments are not limited to these examples.

In embodiments, the advertisement may be stored and retrieved from a storage device as associated with the node. The storage device may store a plurality of advertisements that may be associated with various products and services provided by the merchant. The merchant node may be coupled with the storage device and may be retrieved the determined advertisement.

At block 204, the logic flow 200 includes determining one or more nodes to target for the advertisement. The one or more nodes may be of a plurality nodes that make up a closed mesh network, such as mesh network 100. For example, a merchant node may search the blockchain associated with the mesh network and process transactional data to determine one or more nodes that may be good targets for the advertisements, e.g., nodes associated with users that may be more likely than not to purchase the good or service. The determination may be based on the transactional data stored on the blockchain. For example, the merchant, via the merchant node, may target nodes associated with users that have previously purchased the good or service or a similar good or service.

In other instances, the determination may be analytical and a machine-learning technique may be utilized. For example, embodiments may include utilizing a trained machine-learning model to predict which users are good targets for the advertisement. A machine-learning model may be trained utilizing a dataset that may be actual historical transactional data or a generated dataset. The model may be trained to recognize purchase patterns of users include users that made purchases based on advertisements. The node may then apply the model to the current advertisement and the model may return a result. The result may include an indication of one or more nodes (users) that have a high probability of purchasing the good or service. For example, the results may indicate nodes that are associated with users having a greater than fifty percent probability of purchasing the good or service. Embodiments are not limited to this example and the threshold probability may be preconfigured and/or configured by a user of the system, e.g., a merchant.

In embodiments, the logic flow 200 includes communicating the advertisement on the mesh network at step 206. For example, a merchant node may cause the advertisement to be communicated across the mesh network for other nodes of the network to access. In some instances, the merchant node may communicate the advertisement with an indication of each of the intended targeted nodes, e.g., nodes determined to be good candidates to receive the advertisement in step 204. The indication may be an identifier of the node, an address of the node, an identifier of a user of the node, and so forth. The indication may be utilized by a receiving node to determine whether to present the node to a user or not. For example, the merchant node may include identifiers of targeted nodes. The targeted and untargeted nodes may receive the advertisement, and the targeted nodes may present the advertisement to a user.

Further, the merchant node may communicate the advertisement on the mesh network as a targeted advertisement. In embodiments, the targeted ad payload includes information and data, such as the targeted ad content. The targeted ad content may be visual and/or audio content that may be presented on the node, e.g., on a display and/or played through a microphone.

The targeted ad payload may also include a hash value that may be associated with and used to identify the advertisement. For example, the hash value may be a unique numerical value that is produced and identifies the contents advertisement. In one example, the hash value may be generated by applying a hashing algorithm to a file for the advertisement. However, embodiments are not limited in this manner.

In embodiments, the targeted ad payload may include an incentive offer for nodes of the mesh network. The incentive offer may be an offer for payment to any node that may communicate the advertisement to a node or device outside of the mesh network which results in an engagement of the advertisement and/or purchase of the product or service. The incentive offer may result in payment in the form of a deposit in a cryptocurrency wallet associated with the sharing node and/or another form of payments. As discussed, there may be multiple nodes or a chain of nodes that may share the advertisement with nodes. In these instances, the payment may be divided among the nodes in the chain of nodes sharing the advertisement.

FIG. 2B illustrates an example of a logic flow 220 that may be representative of techniques for enabling a node in a mesh network to detect a transaction associated with an advertisement and provide an incentive. For example, the logic flow 220 may be representative of operations that may be performed in various embodiments by any constituent component of the mesh network 100 (e.g., any of the nodes 102 operating as a merchant node) depicted in FIG. 1.

For example, the logic flow 220 includes determining a user, via a node, engaged an advertisement. In embodiments, the node that engaged the advertisement may not be on a mesh network associated with a merchant node providing the advertisement. The advertisement may be provided to the node via one or more other nodes, one of which is on the mesh network. In embodiments, engagement of the advertisement may include clicking on the node by a user, requesting a website or product page associated with the advertisement, and/or making a purchase of a good or service advertised in the advertisement.

In embodiments, a node may detect the engagement based on information received on the mesh network and/or from one or more other devices. The information may include an identifier of the node utilized to engage the advertisement, a record of one or more nodes that communicated the advertisement, a unique hash value associated and identifying the advertisement, an indication of a transaction based on the advertisement, and so forth. In one example, the merchant node may receive the information via the nodes in the chain of nodes that caused the advertisement to be communicated to the node that engaged the advertisement, e.g., through the chain of nodes. In another example, the merchant node may receive the information through other means, such as direct communication with the node engaging the advertisement. Direct communication may include communications between the engaging node and the merchant that do not include nodes in the chain of nodes. In some instances, the information may be communicated outside of the mesh network. Embodiments are not limited in this manner.

At block 224, the logic flow 220 includes determining one or more nodes that shared the advertisement with the node that engaged the advertisement, e.g., the nodes that communicated the advertisement in the chain of nodes. In one example, a merchant node may receive a record or listing of the nodes in the chain nodes from the engaging node. The record may include an identifier identifying each node that communicated the advertisement for the advertisement to reach the engaging node. The record may be maintained and communicated with each communication of the advertisement. Thus, each node communicating the advertisement may add its identifier to the record. In other instances, the record may be kept on the blockchain and updated with each communication of advertisement.

The logic flow 220 may also include determining an incentive distribution for the one or more nodes at block 226. The incentive distribution may be based on the incentive offer. For example, the incentive distribution may include payment of the incentive offer to a node that shared the advertisement outside of the mesh network that resulted in engaged of the advertisement and/or purchase of the goods or service. In some instances, such as when more than one node shared the advertisement that resulted in a node engaging the advertisement, the incentive distribution may include paying a portion of the incentive offer to each of the nodes. In one example, the portion may be an equal division of the incentive offer to each of the nodes. However, other distribution schemes may be utilized, e.g., the first node that shared the advertisement outside of the mesh network may receive a higher percentage of other nodes that shared the advertisement. Embodiments are not limited to this example.

Further and at block 228, the logic flow 220 includes providing the incentive portion to each of the nodes of the one or more nodes that provided the advertisement to the engaging node. In one example, a merchant node may deposit a cryptocurrency token (or portion of a token) into a cryptocurrency wallet associated with the sharing node. In some instances, a node sharing the advertisement may not have a cryptocurrency wallet. In these instances, the incentive may be provided to the user and/or node via other means, e.g., deposit into a bank account. Further, the manner in which the merchant node distributes the incentive may be based on the type of incentive. For example, if the incentive is a credit with the merchant, the merchant node may provide a credit to the node. Embodiments are not limited to this example.

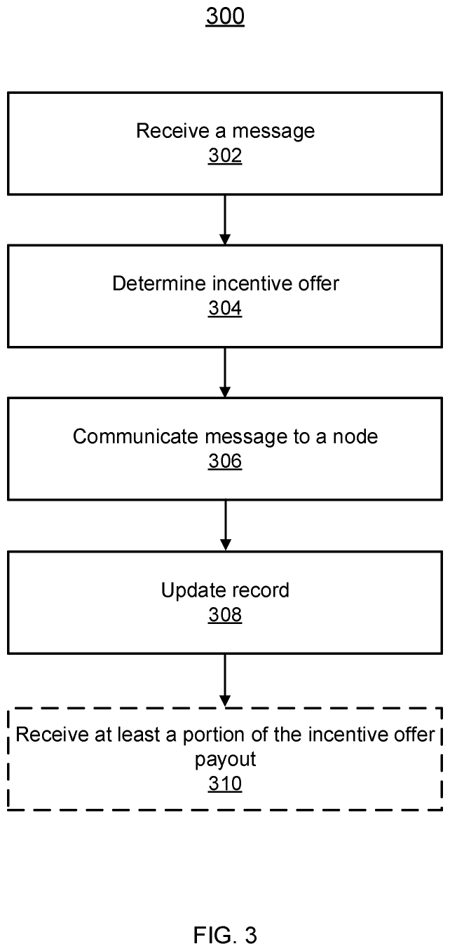

FIG. 3 illustrates an example of a logic flow 300 that may be representative of techniques for enabling a node in a mesh network to provide an advertisement to another node. For example, the logic flow 300 may be representative of operations that may be performed in various embodiments by any constituent component of the mesh network 100 (e.g., any of the nodes 102 operating as a merchant node) depicted in FIG. 1.

In embodiments, the logic flow 300 includes a node receiving a message at block 302. The message may include a targeted ad payload including targeted ad content, a unique hash value, and an incentive offer. In embodiments, the message may be communicated on the mesh network by a merchant node to advertise goods or services by the merchant. In some instances, the message may be received by a targeted node, and the targeted node may present the targeted ad content to a user of node. In other instances, the message may be received by an untargeted node, and the untargeted node may forgo presenting the targeted ad content to a user of the node.

At block 304, the logic flow 300 includes determining an incentive offer received with the message. The incentive offer may be an indication that a merchant, via a merchant node, will pay a user of a node if the node communicates the targeted ad payload to one or more nodes outside or not of the mesh network. In some instances, the incentive offer may be limited to untargeted nodes to communicate the payload to devices outside of the mesh network. However, embodiments limited in this manner. In other instances, both targeted and untargeted may forward the payload to an outside node, and claim the offer.

In embodiments, a node may determine whether to communicate the targeted ad payload to an outside node based on the incentive offer. For example, the node may determine whether the offer (meets or) exceeds a threshold value and if so, may communicate the payload to one or more other devices. If the offer does not exceed the threshold value, the node may forgo communicating the payload. The threshold value may be a monetary amount. In one example, the monetary amount may be set by a user of the node.

At blocks 306, the logic flow 300 includes communicating the message and payload to one or more other nodes or devices not in the mesh network. The node may communicate the message including the targeted payload via one or more wireless and/or wired connections, for example. In some instances, the node may determine which one(s) of a plurality of nodes to send the message and payload. For example, the node may target nodes or devices based on transactional data relating to those nodes, as similarly discussed with respect to the targeted nodes within the mesh network.

In embodiments, the logic flow 300 includes updating a record associated with the targeted ad payload at block 308. The record may include an indication of each node that has shared and/or communicated the targeted ad payload outside of the mesh network. The record may be utilized by a merchant and the merchant's node to determine which nodes to provide the incentive offer payout, for example.

At block 310, the logic flow 300 includes receiving at least a portion incentive offer payout. Note that block 310 is an optional block and may only occur when a user and node engage the advertisement, e.g., access the advertisement and/or make a purchase based on the advertisement. In some instances, a node may receive the entire incentive offer payout if it is the only node in the record. However, the record may reflect a chain of nodes that shared the advertisement, and each node in the chain nodes may receive a portion of the incentive offer payout.

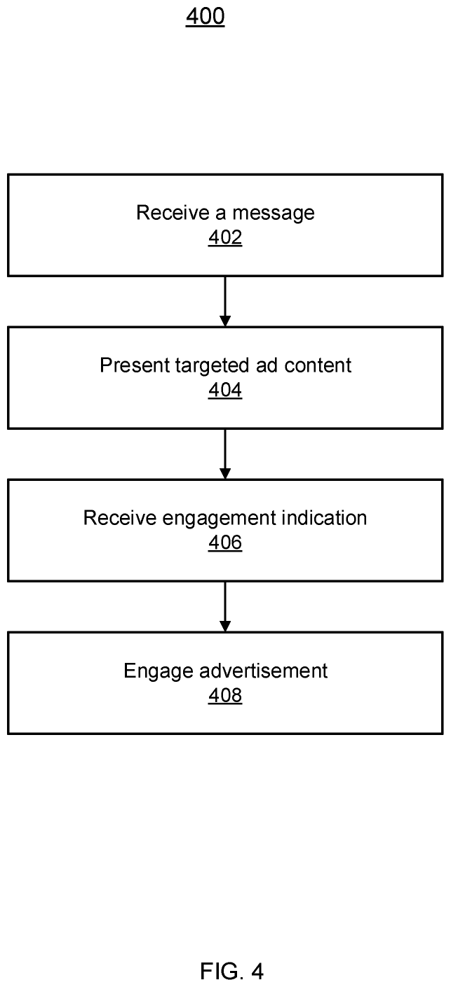

FIG. 4 illustrates an example of a logic flow 400 that may be representative of techniques for enabling a node to engage and advertisement. For example, the logic flow 400 may be representative of operations that may be performed in various embodiments by any constituent component of a node 102 within a mesh network 100 or outside of a node 104 outside the mesh network.

In embodiments, the logic flow 400 includes a node receiving a message at block 402. The message may include a targeted ad payload including targeted ad content, a unique hash value, and an incentive offer. In embodiments, the message may be communicated on the mesh network by a merchant node to advertise goods or services by the merchant. In embodiments, the node receiving the message may be a targeted node for the targeted ad content.

At block 404, the logic flow 400 includes presenting the targeted ad content on the node. For example, a node may present the content on a display and/or through an audio output device such that a user may see and hear the content. In one example, the content may be presented to the user on a webpage in a web browser application. In another example, the content may be presented in application, e.g., in an ad bar.

In embodiments, the logic flow 400 includes a node receiving an engagement indication at block 406. The engagement indication may be based on a user input detected by the node. For example, the node may detect a user input clicking on the advertisement or a touchscreen input selecting the advertisement. Further and at block 408, the node may engage the advertisement. For example, an app on the node may go to a website associated with the advertisement, direct an application to display data relating to the advertisement, and so forth. In some embodiments, engagement may further include a user purchasing the goods and/or services associated with the advertisement.

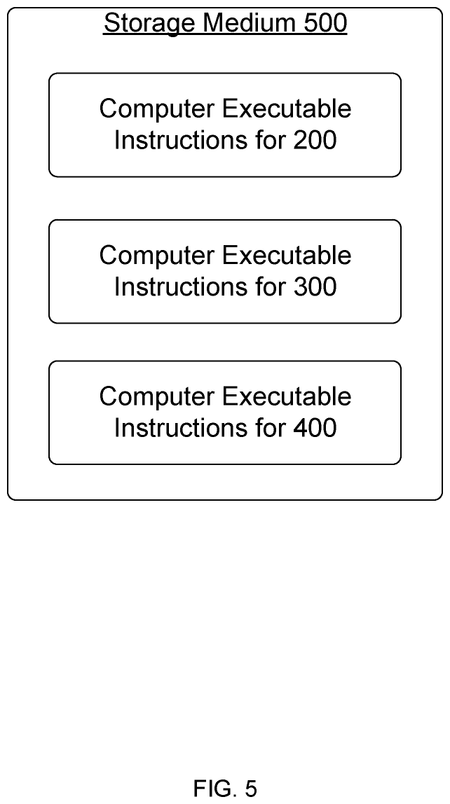

FIG. 5 illustrates a storage medium 500. Storage medium 500 may represent an implementation of a storage device of any electronic device and/or computing device that may operate as a node within the mesh network 100 of FIGS. 1A-1C. The storage medium 500 can comprise any non-transitory computer-readable storage medium or machine-readable storage medium. In various embodiments, the storage medium 500 can comprise a physical article of manufacture. In various embodiments, storage medium 8500 can store computer-executable instructions, such as computer-executable instructions to implement one or more of logic flows or operations described herein, such as the logic flows 200 and 220 of FIGS. 2A and 2B, the logic flow 300 of FIG. 3, and/or the logic flow 400 of FIG. 4. In various embodiments, storage medium 500 can store computer-executable instructions, such as computer-executable instructions to implement any of the functionality described herein in relation to any described device, system, or apparatus. Examples of a computer-readable storage medium or machine-readable storage medium can include any tangible media capable of storing electronic data. Examples of computer-executable instructions can include any type of computer readable code.

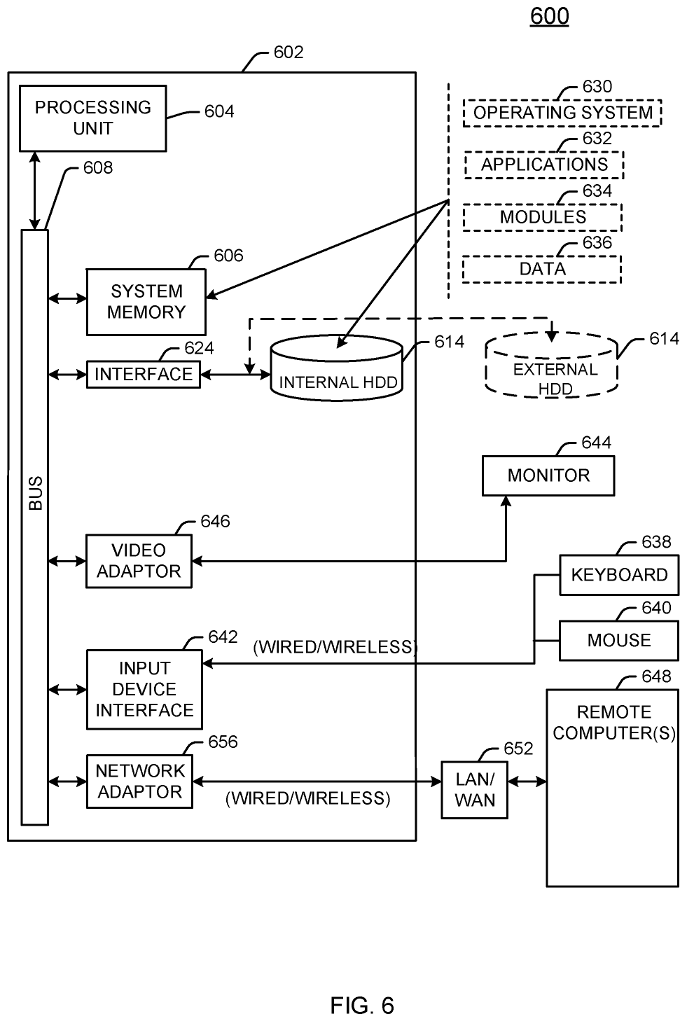

FIG. 6 illustrates a computing architecture 600 that can implement various embodiments described herein. In various embodiments, the computing architecture 600 can comprise or be implemented as part of an electronic device and/or a computing device. In various embodiments, the computing architecture 600 can represent an implementation of any constituent component of the mesh network 100 depicted in FIG. 1. One or more of the constituent components of the computing architecture 600, and/or any constituent component of the mesh network 100, can be implemented in hardware, software, or any combination thereof including implementation based on a storage device (e.g., a memory unit) and logic, at least a portion of which is implemented in circuitry and coupled to the storage device. The logic can be or can include a processor or controller component.

The computing architecture 600 can include various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth.

As shown in FIG. 6, the computing architecture 600 can comprise a computer 602 having a processing unit 604, a system memory 606 and a system bus 608. The processing unit 604 can be any of various commercially available processors or can be a specially designed processor.

The system bus 608 provides an interface for system components including, but not limited to, an interface between the system memory 606 and the processing unit 604. The system bus 608 can be any of several types of bus structure that may further interconnect to a memory bus (with or without a memory controller), a peripheral bus, and a local bus using any of a variety of commercially available bus architectures.

The system memory 606 can include any type of computer-readable storage media including any type of volatile and non-volatile memory. The computer 602 can include any type of computer-readable storage media including an internal (or external) hard disk drive (HDD) 614. In various embodiments, the computer 602 can include any other type of disk drive such as, for example, a magnetic floppy disk and/or an optical disk drive. The HDD 614 can be connected to the system bus 608 by a HDD interface 624.

In various embodiments, any number of program modules can be stored in the drives and memory units 606 and/or 614 such as, for example, an operating system 630, one or more application programs 632, other program modules 634, and program data 636.

A user can enter commands and information into the computer 602 through one or more wired/wireless input devices such as, for example, a keyboard 638 and a pointing device, such as a mouse 640. These and other input devices can be connected to the processing unit 604 through an input device interface 642 that is coupled to the system bus 608. A monitor 644 or other type of display device can also be connected to the system bus 608 via an interface, such as a video adaptor 646. The monitor 644 may be internal or external to the computer 602.

The computer 602 may operate in a networked environment using logical connections via wired and/or wireless communications to one or more remote computers, such as a remote computer 648. The remote computer 648 can be a workstation, a server computer, a router, a personal computer, portable computer, microprocessor-based entertainment appliance, a smartphone, a tablet, a peer device or other common network node, and typically includes many or all of the elements described relative to the computer 602. The logical connections depicted include wired and/or wireless connectivity to networks 652 such as, for example, a local area network (LAN) and/or larger networks, for example, a wide area network (WAN). Networks 652 can provide connectivity to a global communications network such as, for example, the Internet. A network adapter 656 can facilitate wired and/or wireless communications to the networks 652. The computer 602 is operable to communicate over any known wired or wireless communication technology, standard, or protocol according to any known computer networking technology, standard, or protocol.

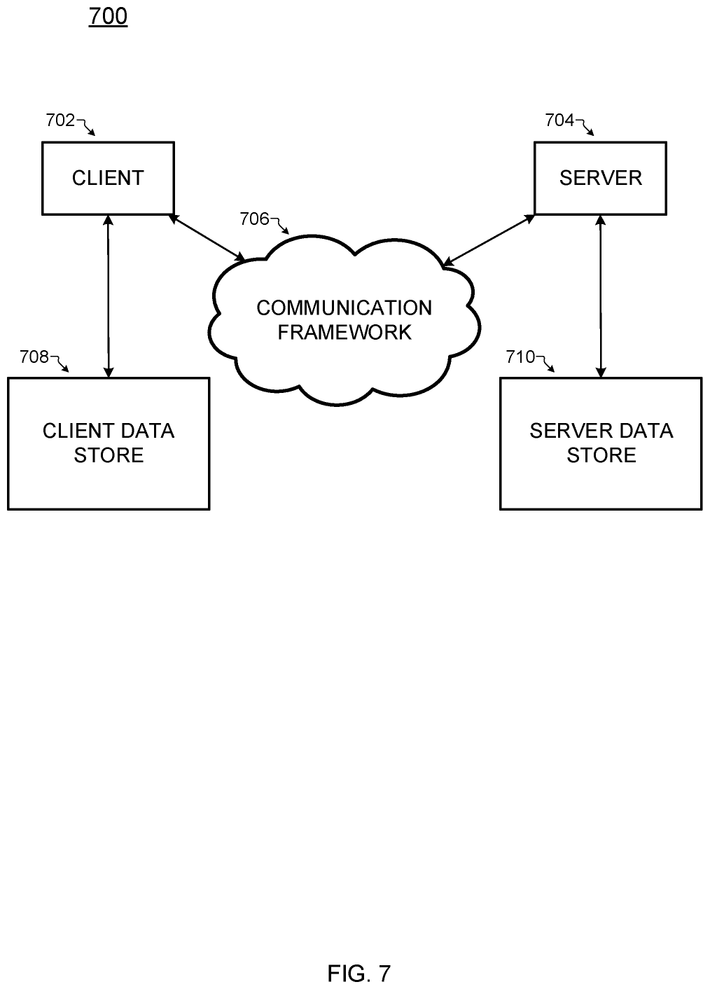

FIG. 7 illustrates a block diagram of a communication architecture 700. The communication architecture 700 can implement various embodiments described herein. As shown in FIG. 7, the communication architecture 700 comprises one or more clients 702 and servers 704. One of the clients 702 and/or one of the servers 704 can represent any constituent component of the mesh network 100.

The client 702 and the server 704 can be operatively connected to a client data store 708 and a server data store 710, respectively, that can be employed to store information local to the respective client 702 and server 704. In various embodiments, the client 702 and/or the server 704 can implement one or more of logic flows or operations described herein.

The client 702 and the server 704 can communicate data or other information between each other using a communication framework 706. The communications framework 706 can implement any known communications technique or protocol. The communications framework 706 can be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators), or any combination thereof. The communications framework 706 can operate over any communication media according to any networking technology including any wired or wireless communications standard or protocol, or any combination thereof.

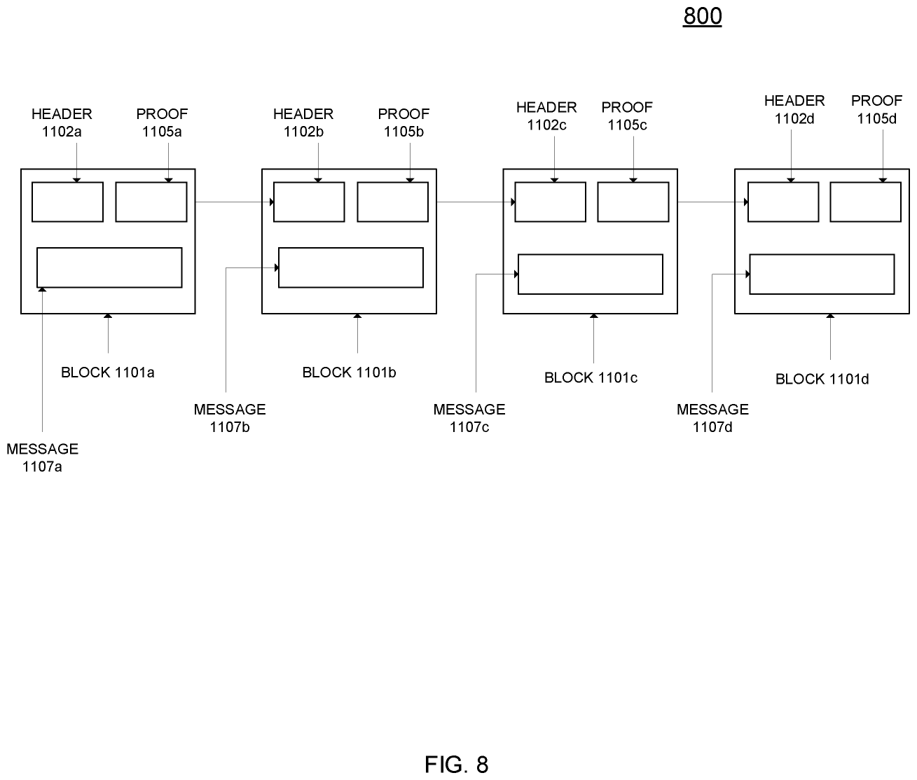

FIG. 8 depicts a logical model 800 of an exemplary blockchain, consistent with disclosed embodiments. The blockchain may comprise blocks, such as blocks 801a-801d. Blocks may include messages, such as message 807a-807d. Generally, blocks may include a header, such as headers 802a-802d, which uniquely identifies each block. The headers 802a-802d may include a hash value generated by a hash function. A hash function is any function that can be used to map input data of arbitrary size to a hash value of a fixed size. For example, a header may include at least one of the previous block's hash value, a hash value generated based on any messages in the block (e.g., a Merkle root), and a timestamp. Consistent with disclosed embodiments, blocks added to a blockchain described herein may satisfy at least one of a proof-of-work condition and a digital signature condition. For example, the headers 802a-802d may include a nonce chosen to ensure the header satisfies the proof-of-work condition. As a non-limiting example, the proof-of-work condition may require the hash of the header fall within a predetermined range of values. As an additional example, the header may be digitally signed with a cryptographic key of an authorized system, and the digital signature may be included in the header. This digital signature may be verified using an available key. The blocks may also include proof components, such as proof components 805a-805d. As an example, the nonce can comprise the proof components 805.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, novel subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
determining, by a node of a plurality of nodes of a closed mesh network, a first subset of nodes, wherein each node of the first subset of nodes are intended targets of a target ad payload;
communicating, by the node, the targeted ad payload and indications of the intended targets onto the closed mesh network, wherein the targeted ad payload is communicated to each of the plurality of nodes including the intended targets and a second subset of nodes of untargeted nodes, wherein the indications to indicate to each of the plurality of nodes whether to present the target ad payload or not, and the targeted ad payload comprising:
targeted ad content comprising an advertisement for a product or service for presentation on the first subset of nodes of the plurality of nodes;
a unique hash value; and
an incentive offer for the second subset of nodes of the plurality of nodes, wherein the incentive offer is limited to the second subset of nodes to communicate the targeted ad payload;
determining, by the node, that a second node of the second subset of nodes communicated the targeted ad content to at least one node not of the closed mesh network via an external network, wherein the closed mesh network and the external network are different networks, and at least a portion of the plurality of nodes of the closed mesh network does not have access to the external network;
determining, by the node, that a third node of the at least one node not of the closed mesh network acted on the targeted ad content based on the unique hash value; and
awarding, by the node, the incentive offer to the second node based on the determination the third node acted on the targeted ad content.

2. The method of claim 1, wherein the incentive offer is awarded to the second node based on initiation a transaction in a blockchain, and the transaction based at least in part on the hash value, and the transaction is a completed sale of a product or service offered by the targeted ad payload.

3. The method of claim 1, comprising determining, by the node, each node of the first subset of nodes are intended targets of the targeted ad payload based on purchase histories stored in a blockchain, and wherein each of the first subset of nodes to receive the targeted ad content.

4. The method of claim 1, comprising:
determining, by the node, the second subset of nodes are not intended targets of the targeted ad payload based on purchased histories store in a blockchain, and wherein the second node of the second subset of nodes to receive the targeted ad content based on a request by the second node.

5. The method of claim 1, comprising:
determining, by the node, a fourth node of the at least one node not of the closed mesh network accessed the targeted ad content based on the unique hash value and at least partially via the third node; and
determining, by the node, that the third node is to receive at least a portion of the incentive offer.

6. The method of claim 1, further comprising:
determining, by the node, a record of nodes of the second subset of nodes through which the targeted ad content has passed; and
determining, by the node, an allocation of the incentive offer shared in predefined ratios to the record of nodes of the second subset of nodes through which the targeted ad content has passed as indicated by the record.

7. The method of claim 1, wherein the incentive offer is a standard fixed value incentive amount.

8. The method of claim 1, wherein the closed mesh network is a secure mesh network based on a cryptocurrency blockchain, the method further comprising:
determining, by the node, at least one authorized cryptocurrency management node in the secure mesh network to provide a cryptocurrency payment system; and
causing payment, by the node via the at least one authorized cryptocurrency management node, the incentive offer earned by the second node.

9. A non-transitory computer-readable medium comprising a set of instructions that, in response to being executed on a computing node, cause the computing node to:
communicate within a closed mesh network having advertising recipient devices and incentive recipient devices connected thereto a targeted ad payload onto the closed mesh network, wherein the incentive recipient devices do not present an advertisement of the targeted ad payload including:
a targeted ad content useable for presentation of the advertisement to users of the advertising recipient devices; and
an incentive offer for presentation on each incentive recipient device, wherein the incentive offer is limited to the incentive recipient devices and offers an incentive earnable by a user via satisfaction of both:
an incentive recipient device associated with the user, configured to act as a communication node to further communicate the targeted ad payload onto a different network, and
the targeted ad payload casted by the incentive recipient device of the user satisfying a predetermined result via an advertising recipient device;
determine the incentive recipient device casted the targeted ad payload onto the different network and the predetermined result are satisfied, and wherein at least a portion of the advertising recipient devices, the incentive recipient devices, or combination thereof does not have access to the different network; and
award the incentive offer to the incentive recipient device based on the determination the incentive recipient device casted the targeted ad payload and predetermined result are satisfied.

10. The non-transitory computer-readable medium of claim 9, wherein the predetermined result is delivery of the targeted ad payload to the advertising recipient device.

11. The non-transitory computer-readable medium of claim 10, wherein the predetermined result is a completed sale of a product or service offered by the targeted ad payload, to the advertising recipient device.

12. The non-transitory computer-readable medium of claim 10, wherein the incentive is a standard fixed value incentive amount.

13. The non-transitory computer-readable medium of claim 9, wherein the set of instructions further cause the computing node to determine the advertising recipient devices are intended targets of the target ad payload based on a machine-learning model to purchase histories of the advertising recipient devices and the incentive recipient devices, the machine-learning model trained to recognize purchase patterns based on the purchase histories.

14. The non-transitory computer-readable medium as claimed in claim 9, wherein the closed mesh network is a secure mesh network based on a cryptocurrency blockchain, and wherein the set of instructions further cause the computing node to:
determine least one authorized cryptocurrency management node in the secure mesh network to provide a cryptocurrency payment system; and
cause payment via the at least one authorized cryptocurrency management node, the incentive offer earned by the incentive recipient device.

15. A computing node comprising:
a storage device; and
logic, at least a portion of the logic implemented in circuitry coupled to the storage device, the logic to:
communicate within a closed mesh network having advertising recipient devices and incentive recipient devices connected thereto a targeted ad payload onto the closed mesh network, wherein the incentive recipient devices are configured to not present a targeted ad content of the targeted ad payload, and the targeted ad payload including:
wherein targeted ad content useable for presentation of an advertisement to users of the advertising recipient devices; and
an incentive offer for presentation on each incentive recipient device, the incentive offer limited to each incentive recipient device offering an incentive earnable by an incentive recipient device;
determine the incentive recipient device casted the targeted ad payload onto a different network and a predetermined result are occurred, and wherein at least a portion of the advertising recipient devices, the incentive recipient devices, or combination thereof does not have access to the different network; and
award the incentive offer to the incentive recipient device based on the determination the incentive recipient device casted the targeted ad payload and predetermined result are satisfied.

16. The computing node as claimed in claim 15, wherein the predetermined result is delivery of the targeted ad payload to the advertising recipient device.

17. The computing node as claimed in claim 15, wherein the predetermined result is a completed sale of a product or service offered by the targeted ad payload, to the advertising recipient device.

18. The computing node as claimed in claim 15, wherein the incentive is a standard fixed value incentive amount.

19. The computing node as claimed in claim 15, further comprising the logic to:
determine a record of nodes through which the targeted ad content has passed; and
determine an allocation of the incentive offer shared in predefined ratios by the nodes through which the targeted ad content has passed as indicated by the record.

20. The computing node as claimed in claim 15, wherein the closed mesh network is a secure mesh network based on a cryptocurrency blockchain, and the logic to:
determine at least one authorized cryptocurrency management node in the secure mesh network to provide a cryptocurrency payment system; and
cause payment via the at least one authorized cryptocurrency management node, the incentive offer earned by the incentive recipient device.
